(19) United States
(12) Patent Application Publication
(10) Pub. No.: US 2018/0049448 A1
(43) Pub. Date: Feb. 22, 2018

(54) MELTED FOOD PRODUCT WATERFALL APPARATUS WITH REMOVABLE DECORATIVE PATTERN PLATE

(71) Applicant: Nostalgia Products LLC, Green Bay, WI (US)

(72) Inventors: Gregg Bond, Beverly Hills, CA (US); Edward E. Boughton, III, Ventura, CA (US)

(21) Appl. No.: 15/239,695

(22) Filed: Aug. 17, 2016

(51) Int. Cl. A23G 1/20; B05B 17/08

(52) U.S. Cl. CPC A23G 1/20; B05B 17/085

(57) ABSTRACT

A waterfall apparatus for viscous food products including a collection bowl. An auger tube extends perpendicular to the bottom surface of the collection bowl. Inside the auger tube is an auger having a spiral flight protruding along the length of the auger. The auger is coupled to a motor which operates to rotate the auger. The spiral flight supports a viscous food product such as melted chocolate received from the collection bowl as the auger rotates, moving the melted chocolate upwardly from the collection bowl to the top end of the auger tube onto a spillway at the top of the waterfall apparatus. The melted chocolate flows from the top end of the auger tube onto the spillway and flows downwardly to the collection bowl, coating one side of one or more removable decorative pattern plate. The spillway is configured to ensure an even flow of chocolate over the entire width of the removable decorative pattern plate.

### BACKGROUND OF THE INVENTION

### 1. Field of the Invention

The invention relates generally to a device providing a melted or other viscous food product that flows over a vertical wall with a fluid material such as melted chocolate or other viscous food product into a container which is continuously recirculated.

### 2. Description of the Related Art

Chocolate fountains which move melted chocolate so that it flows over a number of tiers like a fountain are well known. For example, U.S. Pat. No. 7,021,556, Muir et al., shows in FIG. 1 a prior art chocolate fountain. As shown in FIG. 1, the chocolate fountain includes a container configured to hold and melt chocolate. A hollow barrel is mounted in the center of the container and provides a pathway for melted chocolate to be moved upward, through its hollow center, to the top of the fountain. An auger (not shown) including a spiral flight extending around the length of the auger is mounted within the hollow barrel. The auger engages with and is rotated by a motor in order to lift the melted chocolate upward in the hollow barrel. On the top of the barrel is a crown that fills with chocolate that flows out of the barrel. When the crown is full of melted chocolate, the chocolate begins to fall over the edges of the crown. Attached to the barrel are tiers which vary in size. As the chocolate flows downwardly from the crown, the chocolate flows over each of the tiers, thus forming a multi-level chocolate waterfall. The chocolate fountain also includes a heating element (not shown that is placed within container.

However, chocolate fountains of the type shown in FIG. 1 of Muir et al. can be difficult to assemble, take apart and clean since each of the tiers must be separately removed and cleaned. Additionally, chocolate fountains of the type shown in FIG. 1 are limited to a flow from a top tier to one or more tiers below the top tier.

### BRIEF DESCRIPTION OF THE DRAWINGS

FIG. 1 is a side perspective view of the invented waterfall apparatus.

FIG. 2 is a front elevation view thereof.

FIG. 3 is a side elevation view thereof.

FIG. 4 is an exploded view showing the base and main operative elements thereof.

FIG. 5 is a partial cross-section view taken along line 5-5 of FIG. 2 showing heating and motor elements inside the base of the apparatus.

FIG. 6 is a topside perspective view of an alternate embodiment thereof.

FIG. 7 is a cross-section view taken along line 7-7 of FIG. 6.

FIG. 8 is a side perspective view of another alternate embodiment thereof.

FIG. 9 is a side perspective view of a fourth alternate embodiment thereof.

FIG. 10 is a cross section taken along line 10-10 of FIG. 9.

### SUMMARY OF THE INVENTION

In one embodiment, a device for a melted chocolate or other viscous food product which flows like a waterfall over a generally vertical wall includes a collection bowl having a bottom surface and an outer side surrounding the bottom surface, the collection bowl forming a high thermal conductivity enclosure substantially encasing a heating element. Although the description refers to melted chocolate as the food product, any food product which has some viscosity such as melted cheese, bbq sauce, salad dressings and the like can be used. Of course, for products such as salad dressing, a heater to melt the product is not necessary. The collection bowl has a bottom surface which, if necessary, is substantially evenly heated. The high thermal conductivity enclosure may be made of aluminum. An auger tube having a top end and a bottom end extends substantially perpendicular to the bottom surface of the collection bowl. The auger tube bottom end is adjacent and removably attached to the bottom surface of the collection bowl. Inside the augur tube is an auger having a spiral flight having a plurality of revolutions protruding along the length of the auger in a well known manner. In an embodiment, the auger may be plastic, metal or other suitable material which can be formed with a spiral flight to raised the melted chocolate as the auger rotates. The augur is coupled directly or indirectly to a motor which operates to rotate the auger inside the auger tube. The spiral flight supports the melted chocolate received from the collection bowl as the auger rotates, moving the melted chocolate upwardly from the collection bowl to the top end of the auger tube onto a spillway at the top of the waterfall apparatus.

The melted chocolate flows from the top end of the auger tube onto the spillway and flows downwardly to the collection bowl, coating one side of a removable, generally vertical decorative pattern plate. The spillway is configured to ensure an even flow of chocolate over the entire width of the removable decorative pattern plate.

The high thermal conductivity enclosure may be aluminum or other similar material. The revolutions of the spiral flight should have a pitch which is sufficient to capture the melted chocolate in the collection bowl and a diameter which fits inside the auger tube with a relatively small clearance so that the chocolate will be moved from the collection bowl up through the auger tube to the spillway as the auger rotates. The melted chocolate can be any other melted, typically food, product such as caramel or other melted candy. All of the parts which come into contact with the melted chocolate should be made of an FDA approved material.

### DETAILED DESCRIPTION OF THE INVENTION

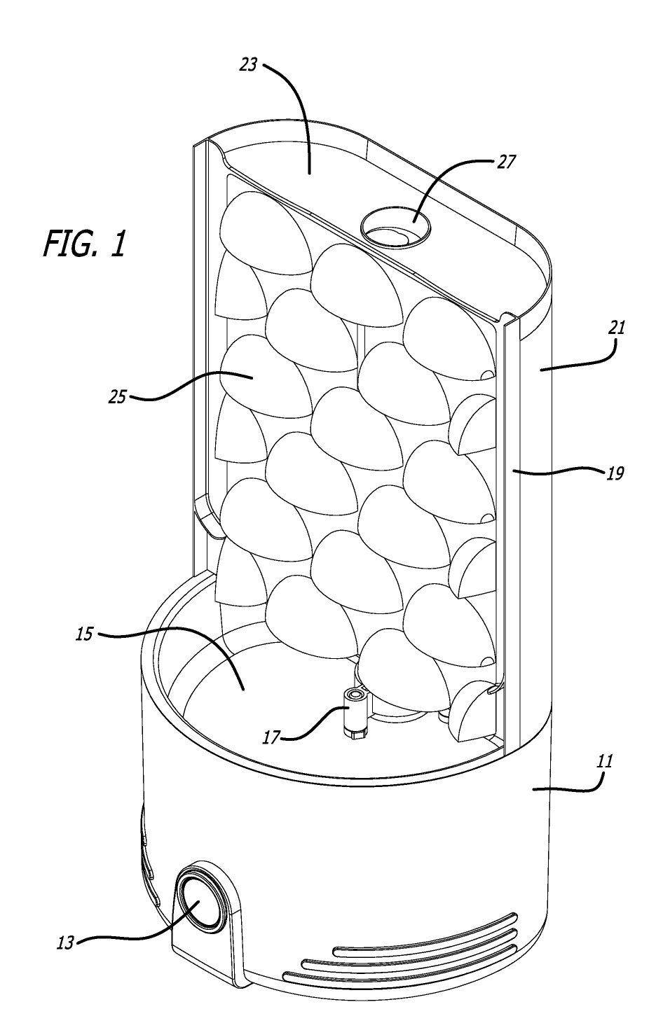

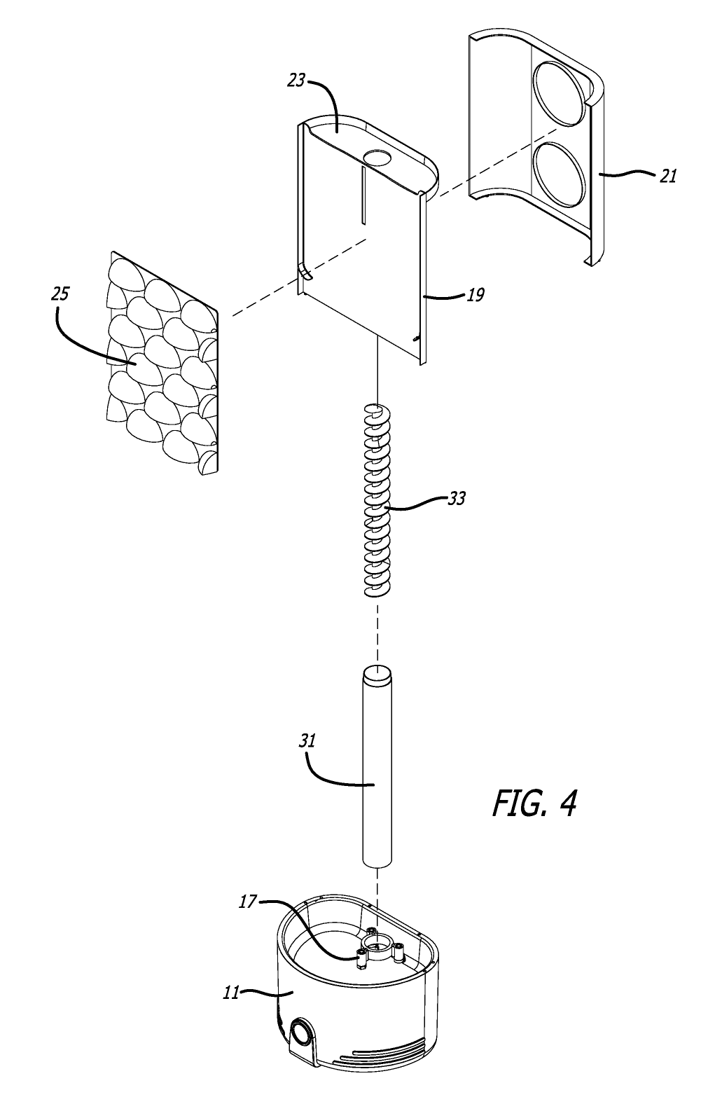

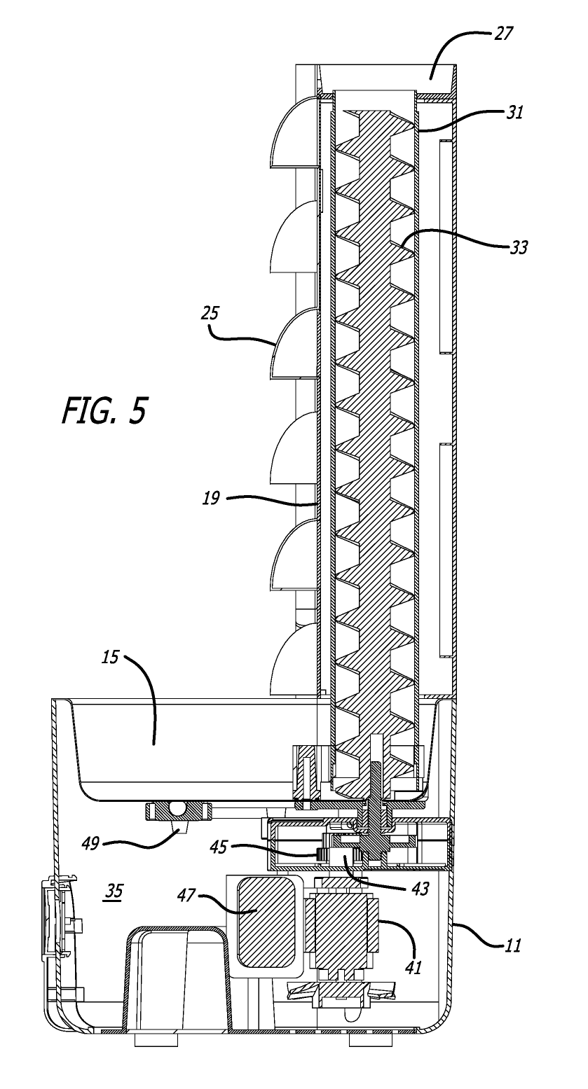

The invented waterfall apparatus as illustrated in FIG. 1 includes a base 11, which includes an on/off switch 13 formed as part of a decorative breast plate. A motor, drive mechanism and heater are contained within base 11 and will be described with reference to FIG. 5 below. The apparatus includes a collection bowl 15 into which melted chocolate or other viscous food product flows by gravity. Attachment mechanism 17 will be described below with reference to FIG. 4. A back wall 19 and back splash 21 fit together to hold a removable decorative pattern plate 25 in place. A spillway 23 which is formed between an upper edge of decorative pattern plate 25 and a rear portion of back wall 19 receives melted chocolate from auger tube opening 27, as will be explained below with reference to FIGS. 4 and 5.

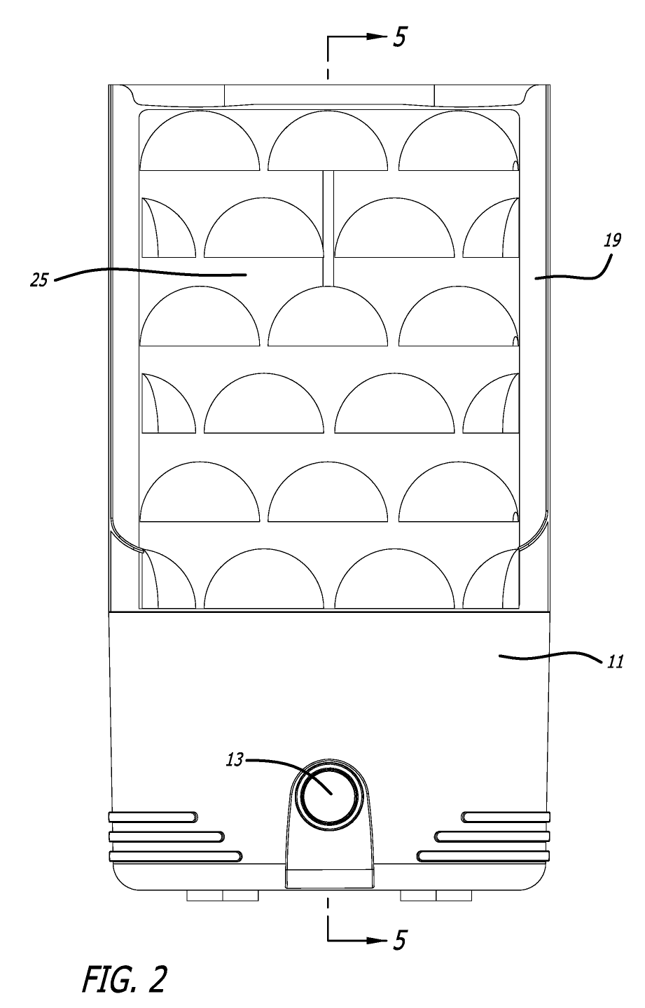

FIG. 2 shows a front face of decorative pattern plate 25 which includes half-moon shaped protrusions over which melted chocolate flowing from spillway 23 flows onto the decorative pattern plate, as will be explained below with reference to FIG. 4. Decorative pattern plate 25 is easily removable from back wall 19, and may be replaced with a decorative pattern plate having a different pattern than the one shown in the Figures. The pattern shown in FIG. 2 has a generally half moon shape and extends from the plate. In an embodiment, the pattern extends from the plate a distance which is sufficient so a food product such as a strawberry or marshmallow placed below one of the pattern extensions is coated by the melted chocolate or other food product flowing over the pattern plate.

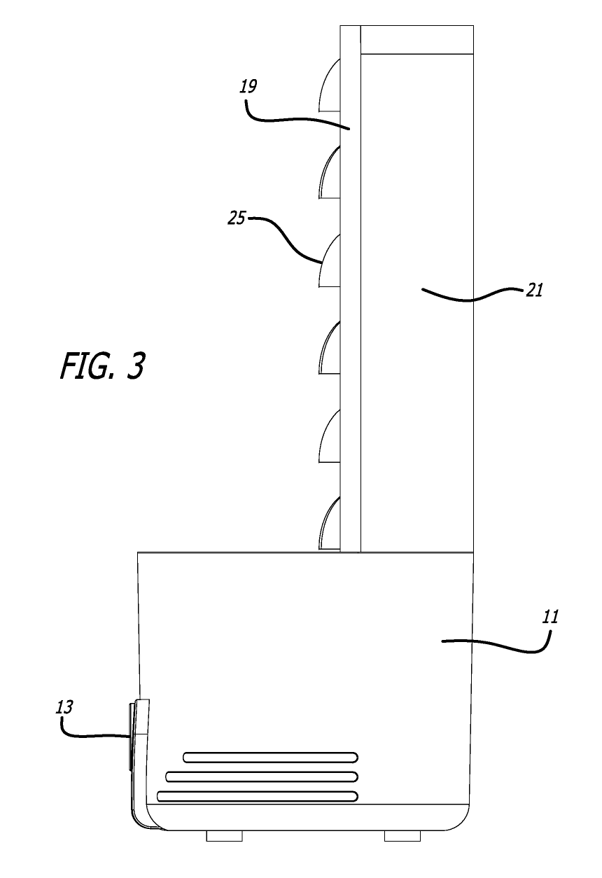

In operation, and with reference to FIGS. 1-3, although not shown in the drawings, melted chocolate contained in collection bowl 15 is transferred via an auger 33 (see FIG. 4) through auger tube opening 27 onto spillway 23. The accumulated melted chocolate in spillway 23 then cascades downward by gravity back to collection bowl 15, coating decorative pattern plate 25 as the melted chocolate cascades into the collection bowl. In a preferred embodiment, in order to ensure that the melted chocolate flows uniformly over the decorative pattern plate, spillway 23 includes a dam 24 at its front edge adjacent to decorative pattern plate 25. The dam is slightly raised in the middle of the spillway and tapers as it extends to the sides of the spillway. The tapering is arranged so that as melted chocolate exits auger tube opening onto spillway 23, the melted chocolate spreads evenly from side to side of the spillway and from its back to its front so that as the melted chocolate accumulates in the spillway, as it spills over dam 24 onto decorative pattern plate 25, it is spread relatively evenly over the width of the decorative pattern plate. Other mechanisms such as tapering the spillway itself can be used to ensure or improve the even flowing of the melted chocolate over the width of the decorative pattern plate. In an embodiment, the decorative pattern plate, rather than extending perpendicular from collection bowl 15 to spillway 23, is angled slightly outward from the spillway to the collection bowl, which assists an even spreading of the melted chocolate over the decorative pattern plate. The precise angle is not important and may vary depending on the viscosity of the food product flowing over the decorative pattern plate. Such angle can be adjusted by any suitable mechanism.

Referring next to FIG. 4, further details regarding the operation of the invented apparatus will now be described with reference to the exploded view shown in FIG. 4. Auger tube 31 fits into collection bowl 15 and is affixed thereto by an attachment mechanism 17. Attachment mechanism 17 may, for example, be a set of three bolts which attach the auger tube to the bottom of collection bowl 15. The specifics of the attachment mechanism are not important to an understanding of the invention. The only requirement is that the attachment mechanism securely connect the bottom end of auger tube 31 to the bottom of collection bowl 15, but allow melted chocolate in collection bowl 15 to enter the base of auger tube 31 so that melted chocolate is moved by operation of auger 33 from collection bowl 15 onto spillway 23. Auger 33 fits into auger tube 31 and, at its bottom end, is removably connected to a motor, as will be described in more detail with reference to FIG. 5. Melted chocolate in container bowl 15 is captured within auger tube 31. As auger 33 rotates, its spiral protrusions lift the melted chocolate from collection bowl 15 up auger tube 31, exiting auger opening 27 onto spillway 23.

Decorative pattern plate 25 is removably connected to back wall 19. Such connection can be by any suitable mechanism, including a spring clip or other mechanism which enables decorative pattern plate 25 to be securely connected to back wall 19 and also easily removable. Back splash 21 connects to the side of back wall 19 opposite decorative pattern plate 25. Back splash 21 is mainly decorative in nature, and the apparatus can be operated without back splash 21 so long as back wall 19 is otherwise securely connected to base 11. In an embodiment, only back splash 21 is securely but removably connected to base 11, with back wall 19 securely but removably connected to back splash 21 and decorative pattern plate 25 securely but removably connected to back wall 19. In this manner, each of the back splash, back wall and can each be easily removed for cleaning and then reconnected.

FIG. 5 is a cross-section taken along line 5-5 of FIG. 2. FIG. 5 shows auger 33 inside auger tube 31. Melted chocolate (not shown) in collection bowl 15 flows to the base of auger tube 33. As auger tube 33 rotates, melted chocolate from collection bowl 15 is raised and is discharged from auger tube opening 27. The precise mechanism by which melted chocolate is moved by auger 33 is well known in the art, with the mechanism described in Muir et al., U.S. Pat. No. 7,021,556, being one example.

Included within base 11 is motor, transformer, heater and gear mechanism space 35. Motor 41 operates by electrical power applied, which causes a shaft 43 to rotate, which in turn rotates gear mechanism 45, causing auger 33 to rotate around its vertical axis. Transformer 47 provides electrical power at an appropriate level for use by motor 41 and heater 49. Heater 49 is a heating element used to supply heat to provide a gentle heat to the melted chocolate or other viscous food product which must be heated to be maintained in a viscous form contained in collection bowl 15 to keep the melted chocolate at a temperature which enables it to flow and be moved by operation of auger 33.

Preferably, the apparatus includes an on/off switch 13 which supplies power to through transformer 47 to motor 41 and heater 49 during operation. On/off switch can be a 2-way on/off switch only, or a 3-way switch. In a 3-way switch configuration, position 1 is off, position 2 is motor on, heater off and position 3 is motor on, heater on. Of course, other positions can be added, for example, to provide a heater on, low position and a heater on, high position. The specifics of such a switch and the number of switch positions in not important for an understanding of the invention, and are well known in the art.

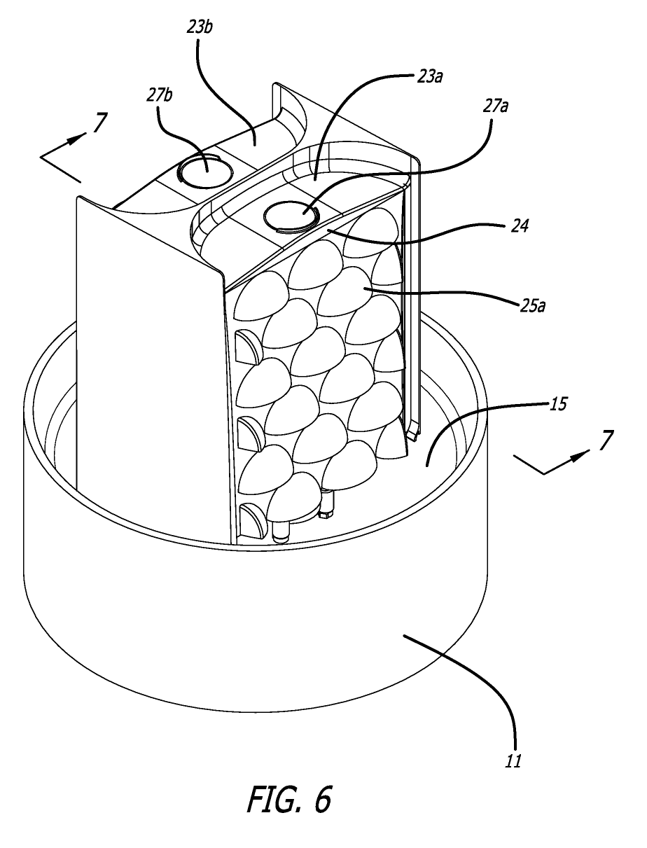

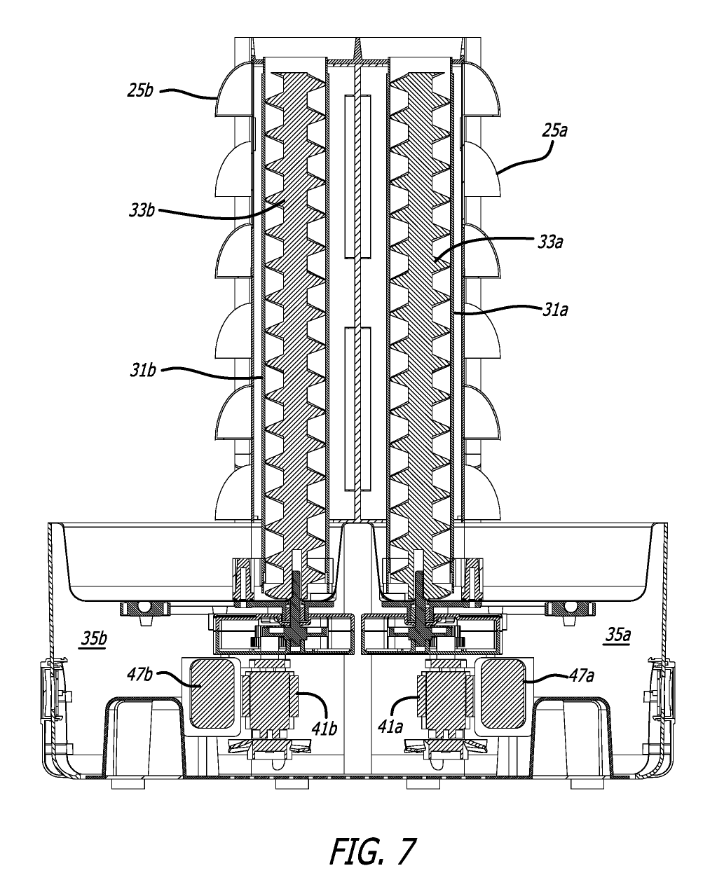

FIGS. 6 and 7 illustrate an alternate embodiment of the invention which includes the same basic elements as the first embodiment, but also includes a second decorative pattern plate 25B as well as a first decorative pattern plate 25A, spillways 23A and 23B and auger tube openings 27A and 27B. As shown FIG. 7 which is a cross section taken along line 7-7 of FIG. 6, each of the decorative pattern plates 25A and 25B has a corresponding auger tube opening 27A and 27B, auger tube 31A and 31B, auger 33A and 33B, motor, transformer heater and gearing space 35A and 35B, motor 41A and 41B, and heater 47A and 47B. Although not separately numbered in FIG. 7, motor, transformer, heater and gearing space 35A and 35B each include a motor, motor shaft, transformer, heater and gear mechanism as described with reference to FIG. 5.

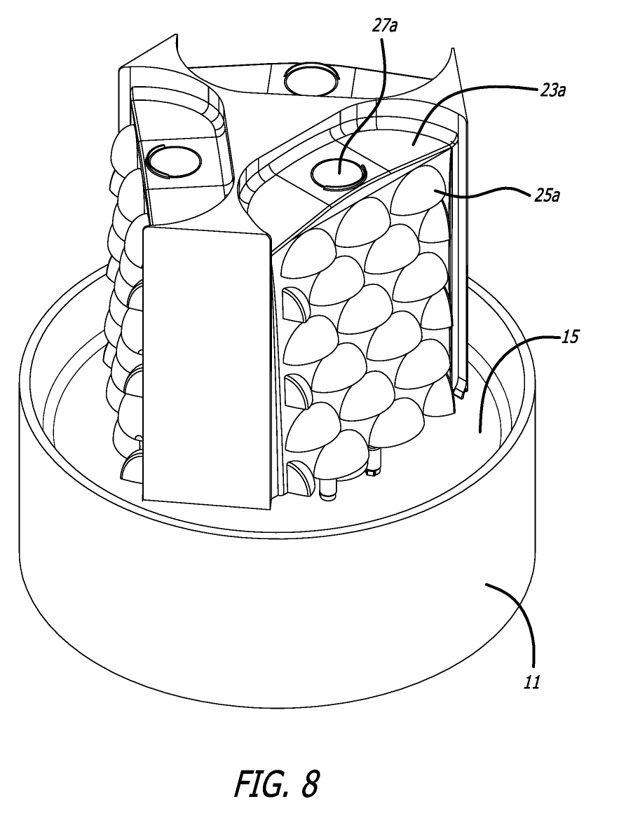

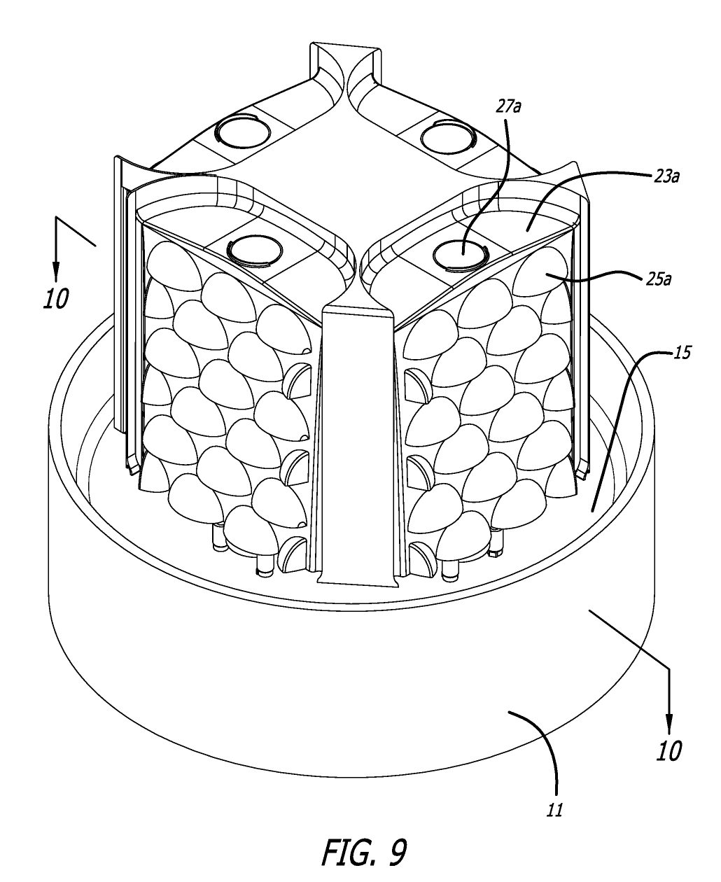

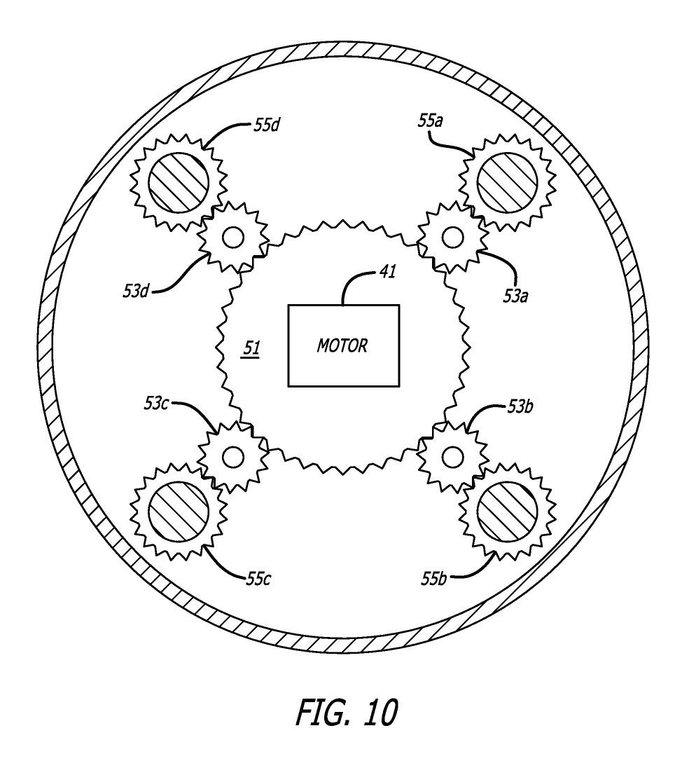

FIGS. 8 and 9 show alternate embodiments which include three decorative pattern plates and four decorative pattern plates, respectively. As shown in FIG. 8, the three decorative pattern plates are arranged in a triangular configuration, while n FIG. 9, the decorative pattern plates are arranged in a square or rectangular configuration. All the elements shown in FIGS. 8 and 9 have corresponding elements as was the case with the first embodiment showing a single decorative pattern plate. In the FIG. 8 and FIG. 9 embodiments, although each motor can have a corresponding motor and gear mechanism, as shown in FIG. 10, which is a cross section of FIG. 9 taken along line 10-10, instead of having a separate motor and gear mechanism for each auger, a single motor 41 can be centrally located which rotates a first gear 51, which in turn rotates gears 53A, 53B, 53C and 53D, which in turn rotate gears 55A, 55B, 55C and 55D. In this connection, each of gears 55A, 55B, 55C and 55D is connected to an auger (not shown) corresponding to auger 33 shown in FIG. 4.

In each of the alternate embodiments, the arrangement of the decorative pattern plate, whether one, two, three or four, is the same as was the case for the first embodiment showing a single decorative pattern plate 25. Although the embodiment shown in FIG. 10 includes a single motor having more power as compared each of four motors in an embodiment with one motor per auger, the specifics of such motor or motors and corresponding gear mechanism would be well within the abilities of persons having ordinary skill in the art to determine.

We claim:

1. A waterfall apparatus comprising:
a base supporting a collection bowl configured to receive a viscous food product;
a backsplash coupled to said base at one end and including a spillway at a second end;
a decorative pattern plate removably coupled to said backsplash extending from said one end to said second end of said backsplash;
an auger tube disposed between said decorative pattern plate and said backsplash, extending from said collection bowl to said spillway;
an auger disposed within said auger tube extending the length of said auger tube;
a motor and disposed within said base, said motor operatively coupled to said auger, wherein
rotation of said motor causes rotation of said augur which results in said viscous food product in said collection bowl to be raised by said auger, through said auger tube, through an augur tube opening in said spillway onto said spillway, and
said spillway is configured to enable said viscous food product in said spillway to flow substantially evenly over said decorative pattern plate.

2. The waterfall apparatus defined by claim 1 wherein said spillway includes a dam at an edge of said spillway adjacent to said decorative pattern plate tapered from a middle portion of said spillway to opposite side edges of said spillway.

3. The waterfall apparatus defined by claim 1 wherein said augur tube is removably coupled to a bottom surface of said collection bowl.

4. The waterfall apparatus defined by claim 1 comprising a second a backsplash coupled to said base at one end and including a second spillway at a second end;
a second decorative pattern plate removably coupled to said second backsplash extending from said one end to said second end of said backsplash;
a second auger tube disposed between said decorative pattern plate and said second backsplash, extending from said collection bowl to said second spillway;
a second auger disposed within said second auger tube extending the length of said second auger tube,
wherein said decorative pattern plate and said second decorative pattern plate face in opposite directions.

5. The waterfall apparatus defined by claim 4 further comprising a second collection bowl, a second motor coupled to said second auger, and a second heater, wherein said second motor, and said second heater are disposed with a second base separate from and adjacent to said base, and said second collection bowl is supported by said second base and is separate from and adjacent to said collection bowl.

6. The waterfall apparatus defined by claim 1 comprising a second and a third backsplash each coupled to said base at a respective one end and each including a respective second spillway at a respective second end;
a second decorative pattern plate removably coupled to said second backsplash extending from said respective one end to said respective second end of said backsplash;
a third decorative pattern plate removably coupled to said third backsplash extending from said respective one end to said respective second end of said backsplash;
a second auger tube disposed between said second decorative pattern plate and said second backsplash, extending from said collection bowl to said respective second spillway;
a third auger tube disposed between said third decorative pattern plate and said third backsplash, extending from said collection bowl to said respective second spillway;
an second auger disposed within said second auger tube extending the length of said second auger tube;
an third auger disposed within said third auger tube extending the length of said third auger tube,
wherein said decorative pattern plate, said second decorative pattern plate and said third decorative pattern plate are arranged to form a triangular configuration.

7. The waterfall apparatus defined by claim 6 wherein each of said second and third augers is coupled to a respective second and third motor.

8. The waterfall apparatus defined by claim 1 comprising:
a plurality of a backsplashes each coupled to said base at one end and including a spillway at a second end;
a plurality of decorative pattern plate each removably coupled to a respective one of said backsplashes, each extending from said one end to said second end of said respective backsplash;
a plurality of auger tubes disposed between a respective one of said plurality of decorative pattern plate and backsplashes, extending from said collection bowl to a corresponding one of said spillways;
a plurality of augers disposed within each disposed within a corresponding one of said auger tubes extending the length of said corresponding auger tube;
a set of gears operative coupled to said motor and to each of said augers wherein rotation of said motor causes rotation of each of said augurs which results in said viscous food product in said collection bowl to be raised by each of said augers, through a respective one of said auger tubes, through respective augur tube opening in a respective one of said spillways onto said respective spillway, and
each said spillway is configured to enable said viscous food product in said spillway to flow substantially evenly over a respective one of said decorative pattern plate.

9. The waterfall apparatus defined by claim 1 further comprising a heater disposed in said base to supply heat to said container sufficient to maintain said viscous food product in a viscous state.

10. The waterfall apparatus defined by claim 1 wherein said decorative pattern plate includes patterns which extend from a surface of said decorative pattern plate to enable a second food product to be coated with said viscous food product when said second food product is placed adjacent to an extended one of said patterns.

11. The waterfall apparatus defined by claim 1 wherein said decorative pattern plate extends perpendicular from the base to the spillway.

12. The waterfall apparatus defined by claim 1 wherein said decorative pattern plate is angled outward from the spillway to the collection bowl.
